(19) United States
(12) Patent Application Publication
(10) Pub. No.: US 2012/0315478 A1
(43) Pub. Date: Dec. 13, 2012

(54) PLASTIC OPTICAL FIBER

(75) Inventors: Masaki Naritomi, Yokohama -shi (JP); Hiroyoshi Inoue, Yokohama-shi (JP)

(73) Assignee: Masaki NARITOMI, Yokohama-shi (JP)

(21) Appl. No.: 13/519,472

(22) PCT Filed: Dec. 22, 2010
(86) PCT No.: PCT/JP2010/007424

§ 371 Date: Jun. 27, 2012

(30) Foreign Application Priority Data
Dec. 28, 2009 (JP) 2009-297582

(51) Int. Cl. B32B 1/00

(52) U.S. Cl. 428/394

(57) ABSTRACT

A plastic optical fiber (POF) is provided which includes a core layer constructed such that a portion at least a certain distance away from a core center, as seen in cross section, contains a plurality of regions of polymer materials having different refractive indices, wherein the average refractive index per circumference continuously decreases with the increase in distance from the core center and wherein the refractive indices are discontinuously distributed on each whole circumference at each distance from the core center.

### TECHNICAL FIELD

The present invention relates to a multimode plastic optical fiber for use with short-range fiber-optic communications and the like.

### BACKGROUND ART

A single-mode optical fiber and a multimode optical fiber have been conventionally known as the optical fiber for use with fiber-optic communications. The short-range fiber-optic communications such as device-to-device communications and intra-apparatus communications by way of intra-premise or in-vehicle LAN wirings, audio/video wirings and the like principally employ the multimode optical fiber.

This multimode optical fiber is classified roughly into quartz-based (glass) optical fibers (hereinafter referred to as GOF) and plastic optical fibers (hereinafter referred to as POF). The POF has advantages over the GOF in that the POF is less expensive and can be increased in core diameter (diameter of a core layer).

Since the POF can be increased in core diameter, it allows for easy connection, for example, which costs the greatest deal of money in wiring work for the short-range fiber-optic communications. The POF also supports a multimode light outputted from a light emitting diode (LED) or vertical cavity surface emitting laser (VCSEL), which requires a less costly optical fiber having a relatively large core diameter. The POF is formed of a polymer material and hence, has an advantage of being less susceptible to failure such as breakage caused by bending, compression or the like.

A conventional POF is exemplified by a step-index (SI) type POF. This SI-POF has an arrangement wherein the core layer and a clad layer have different refractive indices so that the refractive index discontinuously changes at an interface between these layers. Although the SI-POF is fabricated easily at low costs, the SI-POF has a somewhat poor high-speed transmission characteristic because the multimode light inputted thereto is prone to waveform distortion so that the waveform of the outputted multimode light is different from the original waveform. Furthermore, the SI-POF is somewhat inferior in other characteristics such as transmission distance because it suffers a significant transmission loss at wavelengths of a low-cost light source.

In the SI-POF, the clad layer has an outside diameter of 1000 to 750 micrometers and the core layer has a diameter (core diameter) on the order of 980 to 500 micrometers. Operating with an LED light source, for example, the SI-POF is capable of 400 Mbps information transmission over a distance up to 10 m or so. Therefore, the inexpensive SI-POF is used as wirings for short-range audio/video fiber-optic communications or more particularly, used as wirings for audio fiber-optic communications in automobiles.

Furthermore, the SI-POF is also used as optical wave guides, optical switches, optical branching circuits/multiplexers of the intra-apparatus wirings, apparatus modules, board wirings and the like.

In some cases, wiring work for the above-described short-range fiber-optic communications or implementation of the optical wave guide, optical switch or optical branching circuit/multiplexer may require bending of wire or signal path in a radius of 10 mm or less.

In this case, the SI-POF serving as the wiring or signal path of the fiber-optic communications must have a low bending loss characteristic. In general, the greater numerical aperture (NA) the SI-POF has or the more sub-portions the clad layer has, the smaller is the above-described bending loss. There has also been proposed a double clad POF as a POF achieving the low bending loss characteristic by taking advantage of this principle (see, for example, Patent Document 1).

The recent increase in information volume has given rise to a demand for a higher bandwidth version of this type of POF. There are proposed a graded index (GI) -type POF also called a refractive index distribution type (see, for example, Patent Documents 2, 3) and a microstructured (M-type) POF as an application of the photonic bandgap theory (see, for example, Patent Document 4).

In the above-described GI-POF, the refractive index of the core layer progressively decreases with the increase in distance from the center of the core layer while the speed of light increases accordingly. Hence, the GI-POF suffers less waveform distortion of the multimode light inputted thereto and can provide high-speed transmission. The GI-POF may favorably be used for interconnection of intra-premise or in-vehicle LAN wirings or of device-to-device connection, or for intra-apparatus wirings. However, the GI-POF is more difficult to fabricate and more expensive than the SI-POF.

### CITATION LIST

### Patent Literature

PTL 1: JP-A No. H9-101423
PTL 2: PCT Pub. No.: WO93/08488
PTL 3: PCT Pub. No.: WO94/04949
PTL 4: PCT Pub. No.: WO03/052473A1

### SUMMARY OF INVENTION

### Technical Problem

In this type of POFs such as the SI-POF, the multimode light outputted from a light source such as the light emitting diode (LED) or vertical cavity surface emitting laser (VCSEL) is inputted to the POF. The input multimode light is thought to comprise a combination of a light beam running linearly through the center of the core layer and multimode (a multitude of) light beams running along a spiral path progressively increased in radius from the center toward outside.

As indicated by the following formula (1), where C denotes the light speed in vacuum and n denotes the refractive index of a medium, light runs through media of the same refractive index n at the same speed v. In the case of the SI-POF, therefore, the multimode light beams inputted to an input end face thereof are outputted from an output end face thereof at different times as the result of difference between the length of the linear light path through the center and the length of the spiral light path in the peripheral portion of the SI-POF. Accordingly, the waveform of the input multimode light is distorted with time, resulting in bandwidth degradation. This makes it impossible to provide a high-bandwidth POF.

Formula 1

v=C/n (1)

On the other hand, in order to reduce the difference of the output time which is the result of the difference in length between the light path through the center of the core layer and the light path through the peripheral portion thereof, the GI-POF is designed to take advantage of the fact, as suggested by the above formula (1), that the light runs faster through a medium with a lower refractive index n. That is, the GI-POF is imparted with a refractive index distribution in which the refractive index n decreases stepwise from the center of the core layer toward the periphery thereof. If it is assumed in this case that the POF has a circular cross section, the refractive index n varies depending upon radial positions but is constant at any point on the same circumference.

In the GI-POF having this refractive index distribution, the center of the core layer where most light beams run linearly has the higher refractive index so that the light speed decreases, whereas the peripheral portion of the core layer where the light beams run along the large spiral path has the lower refractive index so that the light speed increases. Therefore, the difference in light output time between the center of the core layer and the peripheral portion thereof is decreased so that the high-bandwidth POF can be provided. However, the high-bandwidth POF has problems of limited material of the core layer, difficult fabrication process and increased cost, which will be described hereinlater

This GI-POF is fabricated by a preform method or gas extrusion method including an interfacial-gel polymerization process well known in the art. In the fabrication process, abase polymer forming the core layer and the clad layer is used in combination with a low-molecular-weight organic compound called a dopant and having a greater refractive index n than that of the base polymer in order to impart the above-described refractive index distribution. In this case, the combined use of the base polymer and the dopant having the different refractive indices n involves problems that some selected materials may disable the dopant to accomplish a desired distribution profile and that the addition of the dopant lowers the glass transition point (Tg) of the base polymer.

Specifically, a GI-POF fabricated by the interfacial-gel polymerization process using PMMA (polymethyl methacrylate), which produces a stable polymer by polymeriation, exhibits a distribution curve of refractive index n which is analogous to a quadratic curve as shown in FIG. 8A, for example. The quadratic curve is said to represent an idealistic refractive-index distribution profile of the high-bandwidth POF. However, a GI-POF (FGI-POF) fabricated by using a transparent fluororesin or the like, as set forth in Patent Document 3, exhibits a refractive-index distribution curve conforming to a Gaussian distribution (normal distribution) as shown in FIG. 8B because the dopant is thermally diffused. The fluororesin produces an instable polymer by polymerization, which cannot be used as it is. Hence, a dopant distribution curve, namely the distribution curve of refractive index n delineates the form of trailing skirt which is far from the quadratic curve said to represent the idealistic refractive-index distribution profile of the high-bandwidth POF.

In order to maintain a long-term bandwidth characteristic of the POF, the low-molecular-weight dopant is required to maintain a predetermined distribution profile of the refractive index n in a range of long-term working temperature and not to be diffused improperly. The addition of the low-molecular-weight dopant lowers the glass transition point (Tg) of the base polymer. The base polymer needs to have a glass transition point (Tg) of about 100 degrees C. or more in order to ensure a working temperature of 60 degrees C. or less which is required of indoor LAN wirings, for example. The base polymer needs to have a glass transition point (Tg) of about 125 degrees C. or more in order to ensure a working temperature of 85 degrees C. or less which is required of in-vehicle LAN wirings of automobiles. If the POF is used as wirings installed in a higher temperature environment such as in an automotive engine room, the base polymer needs to ensure a working temperature of 125 degrees C. or less, which requires a glass transition point (Tg) of about 165 degrees C. or more. However, a transparent polymer that satisfies the requirement of high glass transition point (Tg) such as to suppress the dopant diffusion in the range of long-term working temperature is limited. Accordingly, strict limits are imposed on the selection of the materials for the dopant and base polymer.

The GI-POF has disadvantages of limited material of the core layer, difficult fabrication process and high cost.

The above-described SI-POF and GI-POF are adapted to trap the light between the core layer and the clad layer by means of total reflection. On the other hand, the above-described M-POF traps the light between the core layer and the clad layer by utilizing the total reflection in combination with the principle of photonic bandgap which takes advantage of the Bragg condition that the light is reflected back when the light exhibits relatively large refractive index variations in a period substantially comparable with the wavelength of the light. As set forth in Patent Document 4 and US Patent Publication No. 654429B1, the M-POF can achieve both the high bandwidth and low bending loss characteristics. When fabricating the M-POF by the widely known extrusion method or preform method, however, it is necessary to contrive means for maintaining microscopic air holes intact. When used under humid environment or in case of long-term use, the M-POF suffers permeability to vapor because the M-POF includes the air holes and because the base material thereof is a polymer. Further, the M-POF is prone to accumulation of water or the like in the air holes exposed on a cut surface for connection. These are considered to be factors of causing problems such as performance degradation. Therefore, no prospect of actually using the M-POF has yet emerged.

The invention seeks to provide a POF of a novel structure which achieves a higher bandwidth than the SI-POF, features less limitation on the usable polymer materials and easy, low-cost fabrication, and can be adapted for low bending loss.

### Solution to Problem

For achieving the above-described object, a POF according to an aspect of the invention comprises a core layer having a structure in which a portion at least a certain distance away from a core center, as seen in cross section, contains a plurality of regions of polymer materials having different refractive indices, wherein the average refractive index per circumference continuously decreases with the increase in distance from the core center and wherein the refractive indices are discontinuously distributed on each whole circumference at each distance from the core center (Claim 1).

In one embodiment of the invention, there is provided the POF wherein a region of a polymer material having a smaller refractive index than that of a polymer material of a portion at the core center continuously extends outward to a clad layer, and wherein the clad layer has a refractive index equal to or smaller than that of a polymer material having the smallest refractive index in the core layer (Claim 2).

In one embodiment of the invention, there is provided the POF wherein the plural polymer materials include a first polymer material having a predetermined refractive index and a second polymer material having a refractive index smaller by a factor of 0.001 to 0.37 than that of the first polymer material (Claim 3).

In one embodiment of the invention, there is provided the POF wherein the first polymer material and the second polymer material are transparent polymer materials having transmission losses in the range of 4 dB/km to 10,000 dB/km at a wavelength range of 400 nm to 1550 nm (Claim 4).

In one embodiment of the invention, there is provided the POF wherein either one or both of the first polymer material and the second polymer material are elastomer (Claim 5).

In one embodiment of the invention, there is provided the POE further comprising an outer clad layer formed on an outer periphery of the clad layer and having an even smaller refractive index (Claim 6).

In one embodiment of the invention, there is provided the POF wherein one of the polymer materials of the core layer is liquid (Claim 7).

In one embodiment of the invention, there is provided the POF wherein an end treatment is accomplished by using a transparent resin cap (Claim 8).

### Advantageous Effects of Invention

In the POF according to Claim 1 of the invention, the portion at least a certain distance away from the core center of the core layer comprises an assemblage of the plural regions of polymer materials having the different refractive indices. The core layer has the structure wherein the average refractive index continuously decreases with the increase in the distance from the core center and wherein the refractive indices are discontinuously distributed on each whole circumference at each distance from the core center.

As described with reference to the SI-POF, the multimode light inputted to the POF comprises the combination of the light beam running linearly through the core center and the multimode (a multitude of) light beams running along the spiral path progressively increased in radius from the center toward outside. This is apparent from a fact that when light from a laser diode (LD) capable of outputting a linear (single mode) light beam is inputted to the POF, a light beam inputted to a core center portion L1, as seen in a circular cross section of a POF1x shown in FIG. 9, runs linearly, a light beam inputted to a portion L2 on the outside of the portion L1 runs spirally on the same circumference, and similarly, a light beam inputted to a portion L3 on the outside of the portion L2 also runs spirally on the same circumference. It is noted that with the increase in running distance, the inputted single mode light transforms to the multimode light due to a plurality of bent portions and foreign substances in the core layer. However, it is believed as described above that the light runs linearly through the core center while the light runs through the peripheral portion along the spiral path.

When such a multimode light is inputted to the POF of the invention having the above-described structure, at least the light beam inputted to the core peripheral portion runs along the spiral path. At this time, the POF offers the effect to increase the average light speed v just as the GI-POF does, because in the core peripheral portion at least a certain distance away from the core center, the average refractive index continuously decreases with the increase in the distance from the core center. Thus, the POF of the invention acts on the multimode light the same way as the GI-POF so as to achieve the higher bandwidth than the SI-POF.

Further, the GI-POF needs to use the base polymer in combination with the dopant having a different refractive index, which dopant must be uniformly dispersed in a desired distribution profile such that the average refractive index continuously decreases with the increase in the distance from the core center and that an equal refractive index is obtained at any point on a circumference of the same distance from the core center. Furthermore, measures must be taken to prevent such a dopant addition from lowering the glass transition point (Tg) and the like of the base polymer. In contrast, the POF of the invention comprises an assemblage of the plural polymer regions having the different refractive indices, negating the need for dispersing the dopant with such high precisions as to ensure the uniform dopant distribution in the desired profile, or the fear of lowering the glass transition point (Tg) of the base polymer. Hence, the POF of the invention is less limited in the usable polymer materials, allows for low-cost, easy fabrication and can be adapted for low bending loss.

Thus is provided the POF which has the absolutely novel structure, achieving the higher bandwidth than the SI-POF and featuring less limitation on the usable polymer materials, easy, low-cost fabrication and reduced bending loss.

The POF of the invention is applicable not only to the wirings for the above-described short-range fiber-optic communications but also to the optical wave guides, optical switches and optical branching circuits/multiplexers having the conventional SI-POF type structures.

The POF according to Claim 2 of the invention is even further improved in the characteristics and the like because the average refractive index of the core layer continuously decreases as the distance from the core center increases to the clad layer and because the clad layer has the refractive index smaller than that of the outermost circumference of the core layer.

The POF according to Claim 3 of the invention uses the first and second polymer materials having the different refractive indices to form the core layer, thereby affording the effects of the POFs according to Claims 1 and 2.

In the POF according to Claim 4 of the invention, the first polymer material and the second polymer material are polymer materials having transmission losses in the range of 4 dB/km to 10,000 dB/km at the wavelength range of 400 nm to 1550 nm. Therefore, this POF can be configured to achieve a practical transmission loss at any of the wavelengths of 1550 nm, 1300 nm, 850 nm, 780 nm, 650 nm or the like considering the wavelength of the light source for communication purpose or the like.

The POF according to Claim 5 of the invention takes advantage of the fact that the POF of the invention does not use the dopant and hence, not only a transparent polymer having a low glass transition point (Tg) but also a transparent elastomer are usable. Namely, the POF according to Claim 5 can provide the POF of Claim 3 by forming the core layer using the elastomer in place of either one or both of the first and second polymer materials.

The POF according to Claim 6 of the invention can achieve even further improved characteristics and the like by forming the double-clad layer which further includes the outer clad layer formed on the outer periphery of the clad layer and having the even smaller refractive index.

The POF according to Claim 7 of the invention can offer another novel structure by using a liquid in place of one of the polymer materials of the core layer.

In the POF according to Claim 8 of the invention, the end treatment is accomplished by using the transparent resin cap, which provides easy sealing or connection of the end face of the POF formed using the above-described elastomer or liquid. What is more, this POF is advantageous in that the end face is reduced in roughness, suppressing light reflection due to the rough surface.

### BRIEF DESCRIPTION OF DRAWINGS

FIG. 1 is a perspective view showing a part of a plastic optical fiber (POF) according to a first embodiment of the invention.

FIG. 2 is an explanatory diagram of an exemplary configuration of a cross section shown in FIG. 1 and refractive index variation.

FIG. 3A to FIG. 3D are explanatory diagrams each showing another exemplary configuration of the cross section shown in FIG. 1.

FIG. 4 is a perspective view showing a part of a plastic optical fiber (POF) according to a second embodiment of the invention.

FIG. 5 is an explanatory diagram of an exemplary configuration of a cross section shown in FIG. 4 and refractive index variation.

FIG. 6 is a perspective view showing a part of a plastic optical fiber (POF) according to a third embodiment of the invention.

FIG. 7 is a perspective view showing a part of a plastic optical fiber (POF) according to a fourth embodiment of the invention.

FIG. 8 is a group of explanatory diagrams of refractive index distributions of GI-type plastic optical fibers (GI-POF), FIG. 8A showing a characteristic example of the refractive index variation dn relative to the radius of a POF fabricated by an interfacial-gel polymerization process, FIG. 8B showing a characteristic example of the refractive index variation relative to the radius of a POF fabricated by a thermal diffusion process.

FIG. 9 is a diagram illustrating how single-mode light beams inputted to different places of a core layer of a multimode plastic optical fiber (POF) are propagated.

### DESCRIPTION OF EMBODIMENTS

For more specific description of the invention, the embodiments thereof will be described in detail with reference to FIG. 1 to FIG. 7.

### First Embodiment

A first embodiment of the invention is described with reference to FIG. 1 to FIG. 3.

FIG. 1 shows a part of a POF1a according to this embodiment, which has a cylindrical double-layered structure including a core layer 2 and a clad layer 3 in the order named from the center.

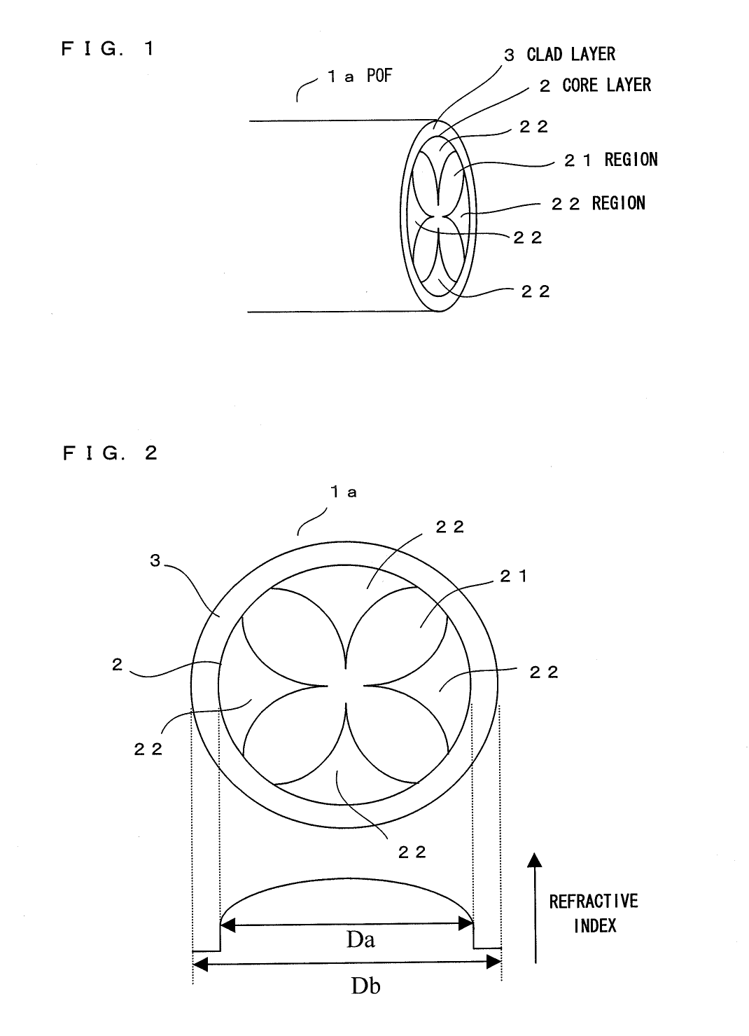

FIG. 2 is an enlarged view of an end face of the POF1a. The core layer 2 is configured such that, as seen in cross section, a portion at least a certain distance away from a core center contains a plurality of regions of polymer materials having different refractive indices. In a nutshell, this core layer consists of a region 21 of a first polymer material A having a predetermined refractive index and a region 22 of a second polymer material B the refractive index of which is smaller by a factor of 0.001 to 0.37 than that of the polymer material A.

In this embodiment, the region 21 occupies a core center portion as seen in the cross section of the core layer 2, while the regions 22 occupy potions on the outside of the region 21, continuously extending outward to the clad layer 3.

The core center portion consists of only the region 21, while the proportion of the region 22 progressively increases with the increase in distance from the core center. As a result, the average refractive index per whole circumference of the core layer 2 continuously decreases with the increase in distance from the core center, as illustrated by the refractive index variation shown in FIG. 2. As measured on the same circumference, a segment belonging to the region 21 exhibits a refractive index of the polymer material A while a segment belonging to the region 22 exhibits a refractive index of the polymer material B. Hence, the refractive indices are discontinuously distributed on each whole circumference at each distance from the core center.

The clad layer 3 has a refractive index equal to or smaller than that of a polymer material having the smallest refractive index in the core layer 2. In this embodiment, the clad layer has a refractive index equal to or smaller than the refractive index of the second polymer material B.

Having the above-described arrangement, the POF1a of the embodiment achieves a higher bandwidth than the SI-POF as will be described as below. Furthermore, the POF1a is less limited in usable polymer materials A, B and easy to fabricate. What is more, the POF1a can be adapted for low bending loss.

A multimode light inputted to the POF1a comprises a combination of a light beam running linearly through the core center portion and multimode light beams running along a spiral path progressively increased in radius from the center portion toward outside.

In the POF1a, the core layer 2 corresponding to a range Da shown in FIG. 2 comprises an assemblage including the region 21 of the polymer A having the greater refractive index and the regions 22 of the polymer B (low refractive index polymer) having the refractive index smaller by the factor of 0.001 to 0.37 than the above. Accordingly, in a portion at least a certain distance away from the core center (which means to include a portion a certain distance away from the core center and a portion a certain distance away from some point a little distance away from the core center), the average refractive index per circumference continuously decreases as the distance from the core center increases. Thus, the POF1a can obtain the effect to increase the average light speed v just as the GI-POF does. Accordingly, the POF1a acts the same way as the GI-POF on the multimode light propagating in the aforementioned manner so as to be able to achieve the higher bandwidth than the SI-POF.

It is preferred from the viewpoint of fabricating the POF1a that the region 22 of the second polymer material B continuously extends outward to the clad layer 3. The POF1a can be fabricated by, for example, widely known extrusion methods such as a polymerization and extrusion method wherein the POF is fabricated while allowing a monomer of a PMMA (polymethyl methacrylate) based POF to polymerize, and a gas extrusion method utilizing gas pressure instead of screw pressure. Otherwise, the POF1a can be fabricated by a preform method. In a case where the POF is fabricated by the extrusion method particularly excellent in productive efficiency, the POF may be molded into a simple die configuration such as to minimize interface where different kinds of materials contact with each other and to minimize independent existence of discrete portions of different kinds of materials. Thus, the productive efficiency can be increased even further.

The refractive index distribution of the dopant added by a conventional thermal diffusion process is constrained by the Gaussian distribution (normal distribution) and has no freedom. In the core layer 2 according to the invention, however, a profile of the distribution of the average refractive index, progressively decreasing with the increase in distance from the core center, has a degree of freedom. In this regard, the POF1a is easy to fabricate. However, care must be taken in the selection of the configuration of the regions 21, 22, which determines the refractive index distribution and in the selection of the refractive indices of the polymers forming these regions 21, 22. Let nA, nB denote the refractive indices of the regions 21, 22, respectively. If a difference between the refractive indices nA, nB is too great, some combination of an in-use wavelength and a configuration of the regions 21, 22 may induce an effect of the principle of photonic bandgap or the well-known Bragg condition that the light is reflected back when the light exhibits relatively large refractive index variation in a period substantially comparable with the wavelength of the light. Accordingly, the light running along the spiral path in the peripheral portion may become unable to enter the region 22 and run along the spiral path. Consequently, the effect of the invention may not be fully yielded. Although the difference between the refractive indices nA, nB of the regions 21, 22 is relatively small, if a critical angle X (sin X=nB/nA) of an input light is great, namely the input light runs substantially linearly, it is likely that total reflection occurs at an entrance interface between a medium of the higher refractive index and a medium of the lower refractive index, namely an interface between the region 21 and the region 22. The spread of multimode light outputted from the light emitting diode (LED) or vertical cavity surface emitting laser (VCSEL), used as the light source for the multimode POF, namely the area of light emission surface and the numerical aperture (NA) vary depending upon the characteristic of each light source. This dictates the need for defining the configuration and refractive indices of the regions 21, 22 according to the characteristic of each light source employed.

Particularly, a portion near the peripheral portion of the POF1a significantly affects the bandwidth degradation of the core layer 2. The light running through this portion near the peripheral portion of the POF1a travels along the large spiral path which has the greater optical path length. Therefore, the light running along the spiral path is delayed in output time as compared with the light running linearly through the core center, thus exerting the significant influence on the bandwidth degradation. The following measure may be taken depending on some bandwidth of the POF1a. Namely, an arrangement may be made such that only the aforementioned portion at least a certain distance away from the core center, namely only the peripheral portion contains both the regions 21 and 22 so as to impart a refractive index gradient to this portion.

The configuration of the regions 21, 22 of the core layer 2 is not limited to that shown in FIG. 2 but may be made in various ways, provided that consideration is given to that only the peripheral portion contains both the regions 21, 22.

The invention is also applicable to a multi-core plastic optical fiber comprising a plurality of cores and known as a plastic optical fiber featuring low light loss at bending.

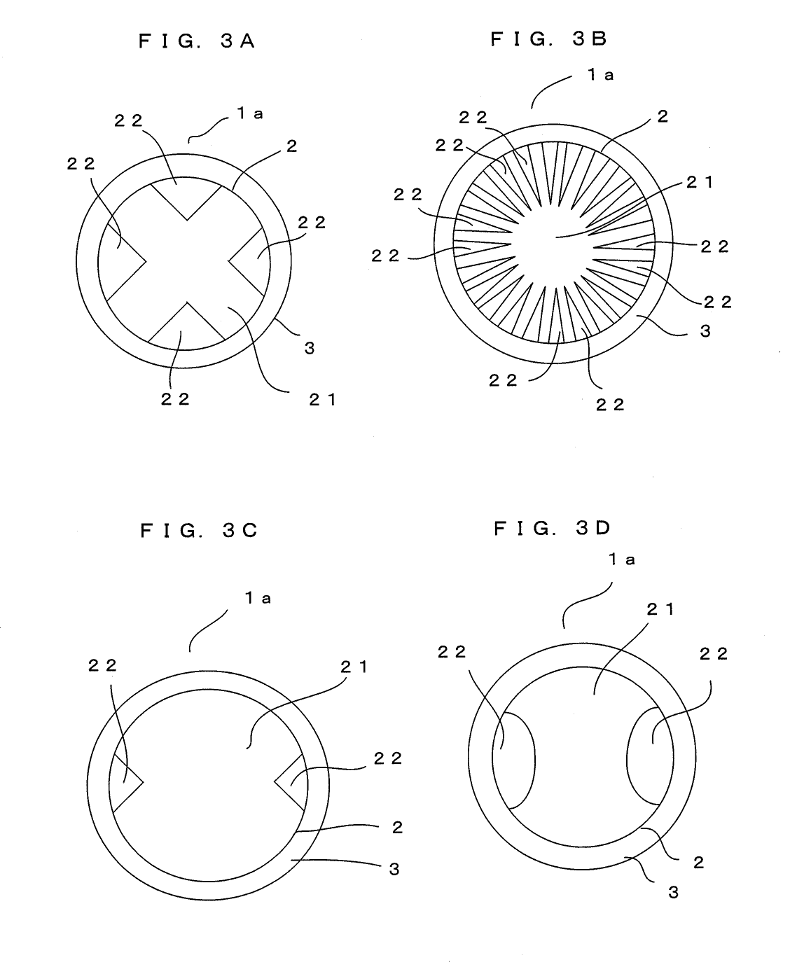

FIG. 3A to FIG. 3D each show another exemplary configuration of the regions 21, 22 of the core layer 2 as seen in cross section.

On the other hand, the clad layer 3 may employ the same polymer material as the second polymer material B (low refractive index polymer) of the region 22 having the refractive index smaller by the factor of 0.001 to 0.37 than that of the first polymer material A forming the region 21 of the core layer 2. For further reducing the bending loss of the POF1a, the clad layer 3 may also employ a polymer material having a refractive index smaller by a factor of 0.001 to 0.37 than that of the polymer material B.

The following is the reason for using the polymer material having the refractive index smaller by the factor of 0.001 to 0.37 than that of the polymer material A as the second polymer material B or the polymer material of the clad layer 3. Each of the first and second polymer materials and the polymer material of the clad layer 3 has an upper limit for the refractive index defined based on a difference between a polypentabromophenyl methacrylate based copolymer (refractive index: 1.710) and CYTOP (refractive index: 1.34) which makes a favorable combination of polymer materials from the viewpoint of low bending loss. A lower limit for the refractive index of each of these polymer materials is defined as a measurable value.

Next, description is made on material characteristics of POF1a in terms of transmission characteristic and light source characteristic.

In the short-range communications employing the POF1a, the POF1a finds wide ranging applications which include: a field of LAN wirings in premise and air crafts and in-plant FA wirings requiring an up-to 1 km transmission range; a field of home network, interconnection and the like requiring an about 100 m transmission range; a field of in-vehicle LAN wirings of automobiles and robot wirings requiring a several-meter transmission range, and a field of intra-apparatus wirings requiring an up-to 1 m transmission range and the like. Where used for intra-apparatus wirings, apparatus modules, board wirings and the like, most optical wave guides, optical switches or optical branching circuits/multiplexers meet a transmission range requirement of lm or less or usually several centimeters.

In order to cover the field of the in-vehicle LAN wirings of automobiles having the transmission range on the order of several meters and the field of the intra-apparatus module, the board wirings and the like having the transmission range on the order of several centimeters, the polymer materials of the core layer 2 and the clad layer 3 of the POF1a may preferably have an upper limit for the transmission loss set to 10,000 dB/km. It is also preferred to set a lower limit for the transmission loss to 4 dB/km, a theoretical transmission loss value of “CYTOP” a trade-name product commercially available from Asahi Glass Co., Ltd. and known as a material having the lowest transmission loss among the polymer materials.

Light sources currently used for communication purposes have wavelengths of 1550 nm, 1300 nm, 850 nm, 780 nm and 650 nm. Lasers at wavelengths of 780 nm, 650 nm, 405 nm used for reproducing data recorded on commercially available DVDs and Blu-ray discs and LEDs for lighting purpose at wavelengths of 630 nm, 520 nm and 430 nm have also been developed as a light source for communication purpose, having a high potential to be used as the light source in future. In order to utilize the light sources at these wavelengths, the polymer material forming the core layer 2 of the POF1a may preferably cover the transmission loss in the wavelength range of 400 nm to 1550 nm. It is preferred to set the transmission loss to 10,000 dB/km or less in this wavelength range.

Next, description is made on specific examples of the first and second polymer materials A, B of the core layer 2 and the polymer material of the clad layer 3.

In the light of the above-described refraction index, transmission loss and the like, polymers suitable for use as the first and second polymer materials A, B of the core layer 2 and the polymer material of the clad layer 3 may favorably be polymers modifiable with compounds containing a benzene ring, fluorine, chlorine, bromine, sulfur, phosphor and the like or polymers adjustable in content ratio such that a desired refractive index can be obtained easily.

Specific examples of the preferable first and second polymer materials A, B of the core layer 2 and the preferable polymer material of the clad layer 3 include polystyrene polymers, polyvinylchloride polymers, PMMA polymers, polycarbonate polymers, fluoropolymers, cycloolefin polymers, polyaryl ester polymers, polyethersulfone polymers, polymethylpentene, ethylene-vinyl acetate copolymers (EVA), EMAA (ethylene-methacrylic acid copolymer), PVA (polyvinyl alcohol), polyimide and the like.

Preferable examples of polystyrene polymer include GP polystyrene (styrene homopolymer), MS (methyl methacrylate-styrene copolymer, SBR (styrene-butadiene rubber) and the like. Specific examples of GP polystyrene include alpha-methylstyrene, chlorostyrene, dichlorostyrene, flame retardants such as bromostyrene and dibromostyrene, and the like. Further, copolymers of these monomers are also regarded as suitable for use as the first and second polymer materials A, B of the core layer 2 and the polymer material of the clad layer 3.

Specific examples of polyvinylchloride polymer include homopolymers of polyvinylchloride, a polyvinylchloride-based copolymer of vinylidene chloride, vinylidene fluoride, vinyl fluoride, or chlorotrifluoroethylene, and polyvinylchloride polymers set forth in JP-A No. 2008-115291, JP-A No. 2008-116614 and JP-A No. 2008-197213.

Specific examples of PMMA polymer include methacrylic ester, acrylic ester, fluorinated acrylic ester, fluorinated methacrylic ester, UV-curable acrylic polymers and the like.

Specific examples of methacrylic ester include methyl methacrylate, ethyl methacrylate, isopropyl methacrylate, t-butyl methacrylate, benzylmethacrylate, phenyl methacrylate, cyclohexyl methacrylate, diphenylmethyl methacrylate, 1-naphtyl methacrylate (refractive index: 1.641) and the like.

Specific examples of acrylic ester include methyl acrylate, ethyl acrylate, butyl acrylate and the like.

Specific examples of fluorinated acrylic ester include 2,2,2-trifluoroethyl acrylate, 2,2,3,3-tetrafluoropropyl acrylate, 1,1,1,3,3,3-hexafluoroisopropyl acrylate, 2,2,3,3,4,4,4-hexafluorobutyl acrylate, perfluorohexylethyl acrylate and the like.

Specific examples of fluorinated methacrylic ester include 2,2,2-trifluoroethyl methacrylate, 2,2,3,3,4,4,4-hexafluorobutyl methacrylate, perfluorooctyl methacrylate, perfluorooctyl methacrylate and the like.

Examples of brominated PMMA polymer having a high refractive index include polypentabromophenyl methacrylate (refractive index: 1.710) and polypentabromobenzyl methacrylte (refractive index: 1.710.). Examples of chlorinated PMMA polymer having an even higher refractive index include polypentachlorophenyl methacrylate (refractive index: 1.608) and the like.

Further, copolymers of zirconium and the above monomers may exemplify the PMMA polymer of high refractive index.

Esters set forth in JP-A No. H6-214125, JP-A No. H9-101423, JP-A No. 2006-188544 and JP-A No. 2007-58047 are also suitable for use as the first and second polymer materials A, B of the core layer 2 and the polymer material of the clad layer 3.

Specific examples of polycarbonate polymer include trade-name polymer products “Iupilon” and “NOVAREX” commercially available from Mitsubishi Engineering Plastics Corporation, “Calibre” and “SD POLYCA” commercially available from SUMITOMO DOW LIMITES, “Panlite” commercially available from TEIJIN CHEMICALS LTD and “TARFLON” commercially available from Idemitsu Kosan, and the like.

Further, the above-mentioned polymers partially substituted with tetrabromobisphenol A (TBA), a high refractive index material also serving as a flame retardant, and polymer materials set forth in JP-A No. H5-70583 and JP-A No. 2002-228852 are also suitable for use as the first and second polymer materials A, B of the core layer 2 and the polymer material of the clad layer 3.

Specific examples of fluoropolymer include aliphatic cyclic fluororesins such as trade-name products “CYTOP” commercially available from Asahi Glass Co., Ltd. and “Teflon AF” commercially available from E.I.du.Pont de Nemours and Company, polychlorotrifluoroethylene (PCTFE), perfluoroalkoxy alkane (PFA), tetrafluoroethylene-hexafluoropropylene copolymer (FEP), tetrafluoroethylene-hexafluoropropylene-vinylidenefluoride copolymer, fluorinated polyimide, fluorine coating materials such as trade-name products “Lumiflon” commercially available from Asahi Glass Co., Ltd., “Cefral Coat” commercially available from Central Glass Co., Ltd., “ZAFLON” commercially available from TOAGOSEI CO.,LTD., “FLUONATE” commercially available from DIC Corporation and “ZEFFLE” commercially available from DAIKIN INDUSTRIES LTD, fluoro-based UV curing resins such as a trade-name product “Optodyne UV” commercially available from DAIKIN INDUSTRIES LTD, polymers such as a trade-name product “AL-Polymer” commercially available from Asahi Glass Co.,Ltd. and copolymers of monomers of the above and other monomers. Particularly preferred are copolymers of polychlorotrifluoroethylene (PCTFE) and the monomers of perfluoroalkoxy alkane, hexafluoropropylene, the aforementioned “CYTOP” and “Teflon (trademark) AF” and the like.

Fluoropolymers set forth in Patent Document 3, JP-A No. H4-189802 and JP-A No. H5-112635 are also suitable.

Specific examples of cycloolefin polymer include trade-name products “APEL” commercially available from Mitsui Chemicals Inc., “Topas” commercially available from Ticona, “ZEONEX” and “ZEONOR” commercially available from ZEON CORPORATION, “ARTON” commercially available from JSR CORPORATION and the like. Further, partially fluorinated cycloolefin polymers having hydrogen substituted with fluorine and per fluorinated cycloolefin polymers are also usable.

Specific examples of polyaryl ester polymer include a trade-name product “U-Polymer” commercially available from UNITIKA LED and the like.

Specific examples of polyethersulfone polymer include a trade-name product “Sumika Excel” commercially available from SUMITOMO CHEMICAL Co.,Ltd. and the like.

Specific examples of polymethylpentene include a trade-name product “TPX” commercially available from Mitsui Chemicals Inc. and the like.

Specific examples of ethylene-vinyl acetate copolymer (EVA) include a trade-name product “EVAFLEX” commercially available from DU PONT-MITSUI POLYCHEMICALS Co.,Ltd. and the like. This product can be made usable by increasing the content of vinyl acetate thereby reducing crystallinity.

Specific examples of EMAA include trade-name products “Nucrel” and “Ionomer” commercially available from DU PONT-MITSUI POLYCHEMICALS Co.,Ltd. and the like.

Specific examples of PVA (polyvinyl alcohol) include a trade-name product “Poval” commercially available from KURARAY CO.,LTD. and the like.

Specific examples of polyimide include 4,4-[p-sulfonylbis(phenylenesulfanyl)]diphthalic anhydride (refractive index: 1.71), fluorinated polyimide and the like or those set forth in JP-A No. H5-1148.

Furthermore, bromine-, chlorine-, fluorine-, deuterium-modified products of the aforementioned polystyrene polymers, polyvinylchloride polymers, PMMA polymers, polycarbonate polymers, fluoropolymers, cycloolefin polymers, polyaryl ester polymers, polyethersulfone polymers, polymethylpentene, ethylene-vinyl acetate copolymers (EVA), EMAA, PVA (polyvinyl alcohol) and polyimide, or copolymers of these and the other aforementioned monomers are also suitable for use as the first and second polymer materials A, B of the core layer 2 and the polymer material of the clad layer 3.

In a case where the region of the second polymer material B accounts for a small proportion of the core layer 2, the second polymer material B of the core layer 2 may also comprise the first polymer material A added with a dopant of low refractive index. In this case, the glass transition point (Tg) of the second polymer material B is lowered by the addition of the dopant. With the small proportion of the region of the second polymer material, however, the POF as a whole can maintain resistance to high temperatures, allowing for the addition of dopant.

A part or the all of the first or second polymer material A, B of the core layer 2, or of the polymer material of the clad layer 3 may comprise a transparent elastomer.

Usable elastomer materials of the invention preferably include thermoplastic elastomers and unvulcanized rubbers.

Examples of suitable thermoplastic elastomer include: styrene elastomers such as a styrene-based copolymer of polybutadiene, hydrogenated polybutadiene, polyisoprene or hydrogenated polyisoprene; polyurethane elastomers (TPU) such as trade-name products “PELLETHANE” commercially available from Dow Chemical Company and “KURAMIRON” commercially available from KURARAY CO.,LTD.; polyester elastomers (TPEE) such as a trade-name product “PELPRENE” commercially available from TOYOBO CO.,LTD.; and fluoroelastomers such as a trade-name product “DAI-EL Thermoplastic” commercially available from DAIKIN INDUSTRIES LTD.

Examples of unvulcanized rubber include butadiene rubbers, butyl rubbers, ethylene-propylene rubbers, epichlorohydrin rubbers, silicone rubbers, nitrile rubbers, chloroprene rubbers, acrylic rubbers, fluororubbers, styrene-butadiene rubbers, chlorinated polyethylene rubbers, nitrile rubbers and the like.

The thermoplastic elastomers or unvulcanized rubbers may also be used in a method where the plastic optical fiber of the invention is cross-linked in an extrusion molding process.

Examples of fluororubber particularly expected to exhibit high optical transparency in the near-infrared region include tetrafluoroethylene-propyrene rubber (FEPM), tetrafluoroethylene-fluoromethyl vinyl ether rubber (FFKM), difluorovinylidene-tetrafluoroethylene-hexafluoropropyrene rubber, difluorovinylidene-hexafluoropropyrene rubber, difluorovinylidene-hexafluoropropyrene rubber, difluorovinylidene-tetrafluoroethylene-fluoromethyl vinyl ether rubber and the like. These rubbers are suitable as an alternate material for the first and second polymer materials A, B of the core layer 2 and the polymer material of the clad layer 3.

Examples of the alternate rubber material also include trade-name products “AFLAS” commercially available from Asahi Glass Co.,Ltd., “Kalrez” and “Viton” commercially available from DU PONT, “DAI-EL” commercially available from DAIKIN INDUSTRIES LTD, “Tecnoflon” commercially available from Solvey Solixis, and the like.

In the fabrication of the POF1a, the first and second polymer materials A, B of the core layer 2 and the polymer material of the clad layer 3 are selected from the aforementioned multitudes of polymers in the light of the refractive indices and the like. Specifically, polymethyl methacrylate as the polymer material A, a copolymer of methyl methacrylate and 2,2,2-trifluoroethyl methacrylate as the polymer material B, and a homopolymer of 2,2,2-trifluoroethyl methacrylate as the polymer of the clad layer 3 are selected to make a first exemplary combination. To make a second exemplary combination, one of the copolymers of chlorotrifluoroethylene (CTFE) and perfluoroalkoxy alkane that has the higher CTFE content is selected as the polymer material A while CYTOP is selected as the polymer of the clad layer 3. The two types of polymers selected as the first and second polymer materials A, B and the polymer of the clad layer 3 are molded into any one of the configurations shown in FIG. 2 and FIG. 3, for example, using the well-known extrusion method or the like whereby the POF comprising the core layer 2 and the clad layer 3 covering an outer periphery thereof is fabricated.

Now, a more specific example of the fabrication method is described. The POF may be fabricated by an extrusion process using a PMMA polymer as a common POF material. Otherwise, a polymerization and extrusion process may be adopted to fabricate the POF while polymerizing the monomer of the PMMA polymer. Using the monomer as the raw material, the polymerization and extrusion process has a merit of easy removal of foreign substances adversely affecting the transmission loss and the like of the POF. However, the polymerization and extrusion process is not applicable to aliphatic cyclic fluororesin, which produces an instable polymer by polymerization. In this case, it is preferred to adopt a gas extrusion process disclosed in US Patent Publication No. 6527986B2. Although the disclosed gas extrusion process includes a thermal diffuser for dopant, the diffusion of dopant is not needed in the practice of the invention. In this case, therefore, an advantage of further easy fabrication of POF is afforded. A preform method which includes forming a preform of the same configuration as that of the end-product of POF, followed by heat drawing the preform is also suitable as the fabrication method of the invention in a case where the POF is required of a complicated core configuration. It is also possible to fabricate the POF by forming only the core layer 2 by the extrusion method or preform method followed by forming the clad layer 3 by a coating method.

As described above, the POF1a according to the embodiment hereof has the arrangement wherein the average refractive index of the core layer 2 continuously decreases from the core center toward the outside. Therefore, the POF1a has the same effect as the GI-POF on the light running along the spiral path so as to obtain a high bandwidth performance. The POF1a achieves a higher bandwidth than the SI-POF, having less limitation on the usable polymer materials and allowing for low-cost and easy fabrication. Furthermore, the POF1a can be adapted for low bending loss which is an important characteristic of the POF for use with the short-range communications and the like.

The POF1a has the structure wherein the region 22 is formed of the polymer (low refractive index polymer) having the refractive index smaller by the factor of 0.001 to 0.37 than that of the polymer forming the region 21 of the core layer 2 and is continuously extended outward from the core center to the clad layer 3. Further, the clad layer 3 may be formed of the low refractive index polymer. Therefore, the POF1a does not require the use of the low-molecular-weight dopant such as required by the GI-POF. Furthermore, the POF1a obviates the need for diffusing the dopant, affording the advantage that the POF can be easily fabricated at low cost using a simple fabrication method such as extrusion.

The POF1a has a transmission loss in the range of 4 dB/km to 10,000 dB/km at a wavelength range of 400 nm to 1550 nm. In the short-range fiber-optic communications field, the POF1a can be used as interconnections for in-premise LAN and home network or computer-to-computer interconnection; as a device-to-device connector such as HDMI used for interconnection of home appliances; used as intra-apparatus wirings for in-vehicle LAN of automobiles or for connection between ICs, between IC and hard disc or between IC and display; or as optical wave guides, optical switches, optical branching circuits/multiplexers and the like constituting device wirings or board wirings. Besides the short-range fiber-optic communications, the POF1a is also applicable to sensors, light guides and the like.

By the way, the first and second polymer materials A, B of the core layer 2 and the polymer material of the clad layer 3 may further include elastomers (rubber and the like) of the above-described polymers. The elastomer is known as an amorphous organic material having high transparency. Because of the addition of the dopant, the GI-POF permits the use of only polymers having high glass transition points (Tg). In the POF1a which is free from the dopant, polymers and elastomers having low glass transition points (Tg) are also usable so that the range of selection of materials for the core layer 2 and the clad layer 3 is increased even further.

The polymers and elastomers used in the core layer 2 and the clad layer 3 need to have different refractive indices. Therefore, the core layer 2 and the clad layer may preferably employ polymers and elastomers modifiable with compounds containing benzene ring, fluorine, chlorine, bromine, sulfur, phosphor or the like or polymers and elastomers changeable in content ratio such that the refractive index can be changed.

### Second Embodiment

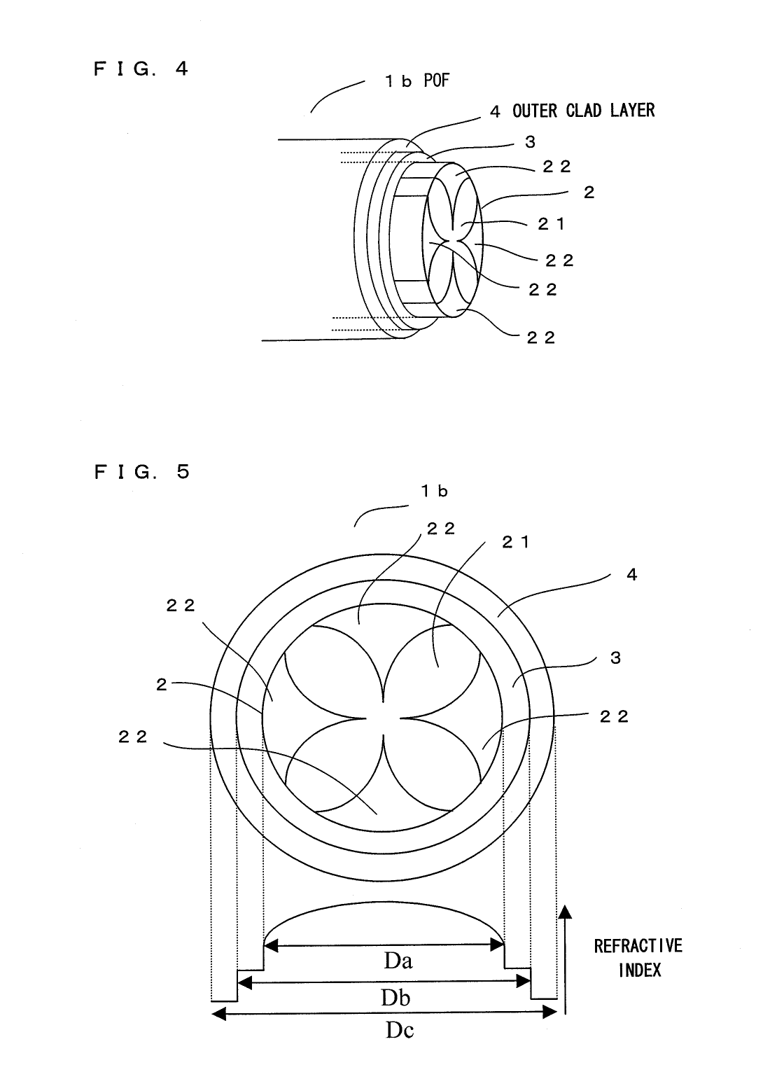

Next, a second embodiment of the invention is described with reference to FIG. 4 and FIG. 5.

FIG. 4 shows a part of POF1b according to the second embodiment of the invention, which further comprises an outer clad layer 4 (double-clad layer) formed on an outer periphery of the clad layer 3 and having an even smaller refractive index.

Similarly to FIG. 2, FIG. 5 shows an enlarged view of an end face of the POF1b. In the figure, a reference character Db representing a refractive index indicates a diameter of a region encompassing the clad layer 3, while a reference character Dc indicates a diameter of a region encompassing the outer clad layer 4.

By virtue of this configuration, the POF1b of this embodiment has an advantage of achieving further decreased bending loss just as the above-described DC-type POF.

In this case, the outer clad layer 4 practically need be formed of a transparent polymer or elastomer having a refractive index smaller by a factor of 0.001 to 0.37 than that of the clad layer 3. The greater the difference of refractive index between the clad layer 3 and the outer clad layer 4, the smaller the bending loss of the POF. In consideration of light leaching into the outer clad layer 4 as well, it is preferred to select the material of the outer clad layer 4 from the polymers and elastomers (rubber material) constituting the core layer 2 and the clad layer 3. However, the outer clad layer is not required to be so low in bending loss as the core layer 2 or the clad layer 3 and hence, the range of material selection is increased even further.

### Third Embodiment

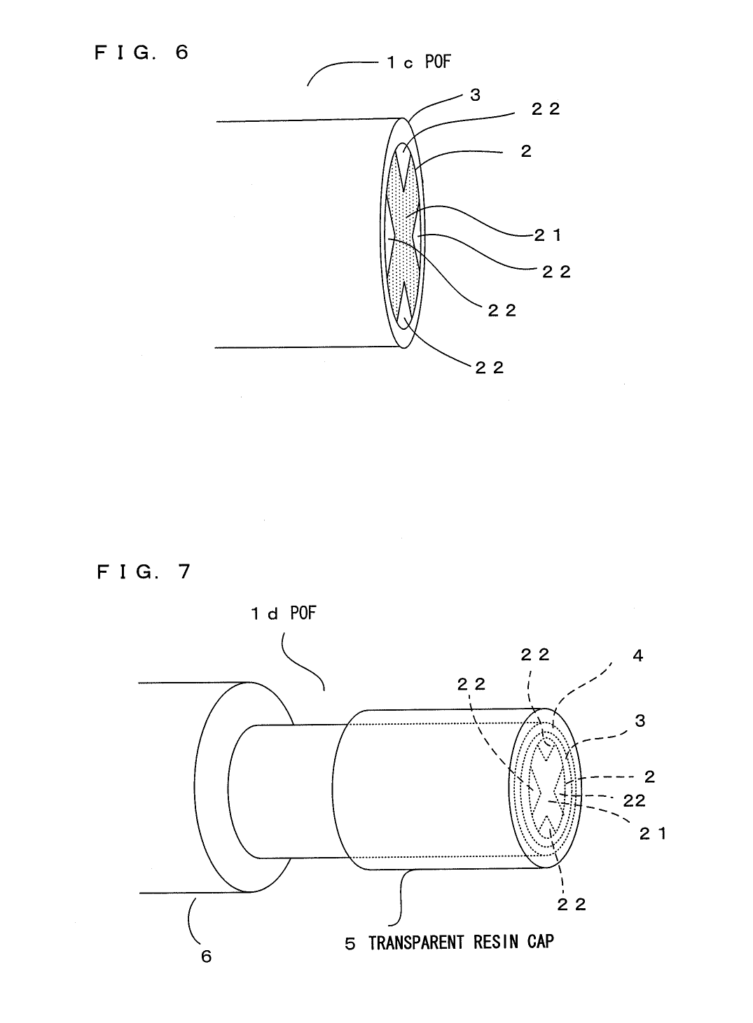

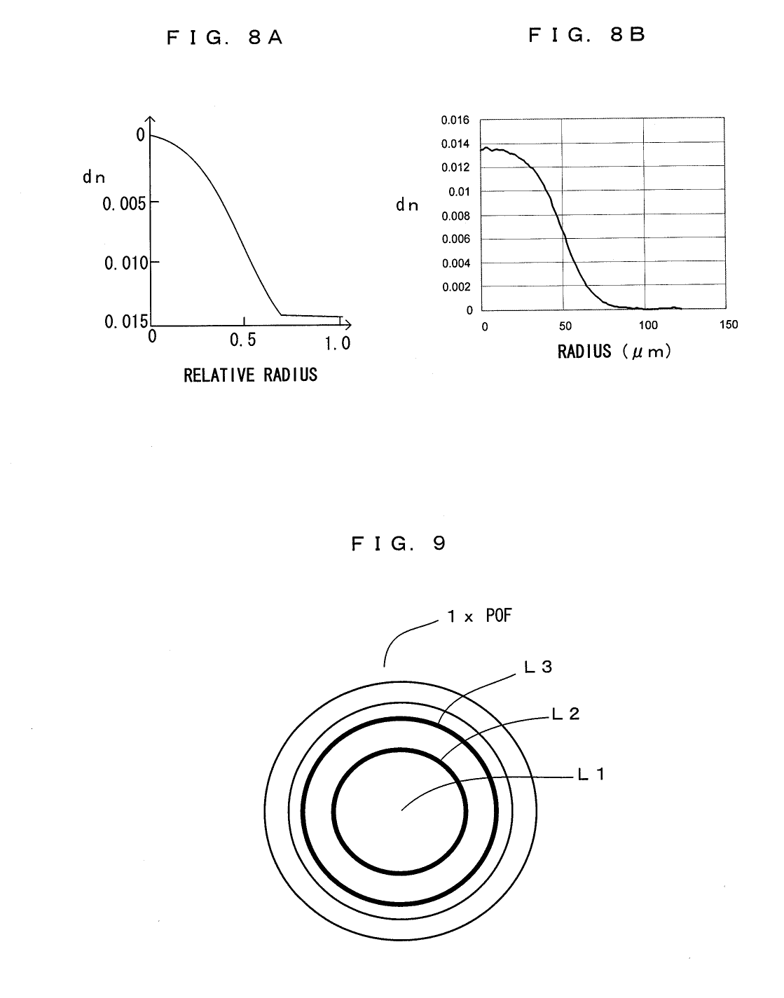

Next, a third embodiment of the invention is described with reference to FIG. 6.

FIG. 6 shows a part of POF1c according to the third embodiment of the invention. The POF1c of this embodiment has an arrangement wherein one of the polymer materials of the core layer or more specifically, the first polymer material A of the region 21 is liquid.

In this case, there is an advantage in that it is easy to prepare a transparent material because the liquid has no crystallinity. The liquid may be an aqueous solution, a solution of organic compound, a solution of low-molecular-weight compound or an oligomer. Both liquid materials having high viscosity and low viscosity are usable. It is noted however that the liquid material desirably has the highest possible refractive index because the liquid is mainly used as an alternate material for the first polymer material A of the region 21 constituting the core layer 2. A solution of organic compound having such a high refractive index includes solutions of organic compounds containing benzene ring, chlorine, bromine, deuterium, sulfur and phosphor. Specific examples of the preferred solution of organic compound include oligomers of the polymers and elastomers cited by the first embodiment, chlorine-base solvents, fluorine-base solvents, benzene-base solvents, silicone oil, aqueous solution of organic salt of high refractive index and the like. Particularly preferred are chlorotrifluoroethylene oligomer, diphenylmethane, dichlorobenzene, chlorobenzene, toluene, pyridine, aqueous solution of calcium carbonate, and liquids of high refractive indices set forth in JP-A No. 2002-53839 and JP-A No. 2007-258664.

The above liquids can be injected into voids in the first polymer material A of the region 21 by way of capillary action. The POF1c can be fabricated using such an injection method.

The POF1c offers the same effects as the POF1a and POF1b.

### Fourth Embodiment

Next, a fourth embodiment of the invention is described with reference to FIG. 7.

FIG. 7 shows a part of POF1d according to the fourth embodiment. The POF1d of this embodiment has an arrangement wherein any one or more than one of the core layer 2, the clad layer 3 and the outer clad layer 4 employs an elastomer or liquid. The POF1d is terminated by attaching transparent resin caps 5 to the opposite ends thereof.

In a case where the elastomer or liquid is used in any one of the core layer 2, clad layer 3 and outer clad layer 4, it is likely that the POF cannot be terminated by polishing as a common POF end treatment. In such a case, as well, the end treatment can be accomplished by attaching the transparent resin cap 5 to the POF, the transparent resin cap used for preventing liquid spill or suppressing light reflection from the rough end face thereof. In a case where all the core layer 2, clad layer 3 and outer clad layer 4 are formed of solid polymer materials, as well, the transparent resin caps 5 may be attached to the POF thereby affording an advantage of reducing on-site operation time for the end treatment and speeding up the connecting work.

Any transparent material having substantially the same refractive index as the materials used in the core layer 2 may be used as the material of the transparent resin cap 5. The polymers and elastomers cited in the foregoing embodiments may be preferably used. The transparent resin cap 5 may have any configuration. The cap may be in the form of a flat lid or may include concavity and convexity such as to be inserted into the core layer 2. The cap may be shaped like a cylindrical cap, as shown in FIG. 7, so as to be utilized as an alternate for a ferrule.

A second feature of the POF1d of the embodiment is that the POF1d is in the form of a cord, having a jacket 6 formed around the clad layer 3 or the outer clad layer 4. Examples of usable material for the jacket 6 include common jacket materials such as polyvinyl chloride, polyethylene and polypropylene, as well as fluororesins adapted for use with plenum and the like.

In a case where the rubber or liquid is used in any one or more than one of the core layer 2, clad layer 3 and outer clad layer 4, a reinforcement layer for increasing strength may preferably be formed between the jacket 6 and the clad layer 3 or between the jacket 6 and the outer clad layer 4. It is also preferred to add the reinforcement layer for increasing strength in a case where the outside diameter of the clad layer 3 or the outer clad layer 4 is 500 micrometers or less, involving a fear of poor strength. Although the reinforcement layer may employ any material that has a sufficient strength for serving the reinforcement purpose, it is more preferred to employ the above-described core materials or clad materials usable in the practice of the invention in the light of inspection of foreign substances and the like contained in the core layer of the POF.

One or more than one length of POF1d may be assembled into a cable. In this case, the cable may include a tension member. If the cable, POF and cord are formed of transparent or translucent materials, such a cable is less distinguishable from wall and may suitably used for indoor wiring.

The invention is not limited to the foregoing embodiments. Rather, the invention can be modified to incorporate any number of variations, alterations, substitutions or equivalents not heretofore described but commensurate with the spirit and scope of the invention. For example, the core layer 2 may comprise an assemblage of regions formed of three or more polymer materials having different refractive indices.

The configurations of the regions 21, 22 of the core layer 2 are not limited to those shown in FIG. 2 and FIG. 3.

Further, the fabrication method and application of the POFs 1a to 1d are not limited.

As a matter of course, the cross section of the POF of the invention may be elliptical, rectangular or the like.

The specific examples of the polymers, elastromers and liquids used in the core layer 2, the clad layer 3 and the like are not limited to those described in the foregoing embodiments.

### INDUSTRIAL APPLICABILITY

The invention is applicable to multimode POFs for wide range of uses. The invention may also be used as an alternate for multimode GOFs.

### REFERENCE SIGNS LIST

1a-1d, 1x: PLASTIC OPTICAL FIBER (POF)

2: CORE LAYER

3: CLAD LAYER

4: OUTER CLAD LAYER (DOUBLE-CLAD LAYER)

5: TRANSPARENT RESIN CAP

21: REGION OF FIRST POLYMER MATERIAL

22: REGION OF SECOND POLYMER MATERIAL

1. A plastic optical fiber, comprising:
a core layer having a structure in which a portion at least a predetermined distance away from a core center, as seen in cross section, comprises plural polymer materials having different refractive indices in a plurality of regions, wherein
an average refractive index per whole circumference continuously decreases with an increase in distance from the core center and
wherein refractive indices are discontinuously distributed on each whole circumference at each distance from the core center.

2. The plastic optical fiber according to claim 1, wherein
a region of a polymer material having a smaller refractive index than that of a polymer material of a portion at the core center continuously extends outward to a clad layer, and
the clad layer has a refractive index equal to or smaller than that of a polymer material having smallest refractive index in the core layer.

3. The plastic optical fiber according to claim 1, wherein
the plural polymer materials include a first polymer material having a predetermined refractive index and a second polymer material having a refractive index smaller by a factor of 0.001 to 0.37 than that of the first polymer material.

4. The plastic optical fiber according to claim 3, wherein
the first polymer material and the second polymer material are polymer materials having transmission losses in the range of 4 dB/km to 10,000 dB/km at a wavelength range of 400 nm to 1550 nm.

5. The plastic optical fiber according to claim 3, wherein
either one or both of the first polymer material and the second polymer material are elastomer.

6. The plastic optical fiber according to claim 5, wherein
a region of a polymer material having a smaller refractive index than that of a polymer material of a portion at the core center continuously extends outward to a clad layer, and
the clad layer has a refractive index equal to or smaller than that of a polymer material having smallest refractive index in the core layer, and
further comprising an outer clad layer formed on an outer periphery of the clad layer and having an even smaller refractive index.

7. The plastic optical fiber according to claim 6, wherein one of the polymer materials of the core layer is liquid.

8. The plastic optical fiber according to claim 7, further comprising a transparent resin cap at an end of the optical fiber.

9. The plastic optical fiber according to claim 2, wherein
the plural polymer materials include a first polymer material having a predetermined refractive index and a second polymer material having a refractive index smaller by a factor of 0.001 to 0.37 than that of the first polymer material.

10. The plastic optical fiber according to claim 9, wherein
the first polymer material and the second polymer material are polymer materials having transmission losses in the range of 4 dB/km to 10,000 dB/km at a wavelength range of 400 nm to 1550 nm.
